(19) United States
(12) Patent Application Publication
(10) Pub. No.: US 2026/0316093 A1
(43) Pub. Date: Oct. 15, 2026

(54) CYCLONE COOLING DEVICE

(71) Applicant: EVERINN INTERNATIONAL CO., LTD., Taichung City (TW)

(72) Inventor: Tsung-Hsin WU, Taichung City (TW)

(73) Assignee: EVERINN INTERNATIONAL CO., LTD., Taichung City (TW)

(21) Appl. No.: 19/283,844

(22) Filed: Jul. 29, 2025

(30) Foreign Application Priority Data
Apr. 15, 2025 (TW) 114114249

(51) Int. Cl. B04C 5/20; B04C 5/103

(52) U.S. Cl. CPC B04C 5/20; B04C 5/103

(57) ABSTRACT

A cyclone cooling device includes a first barrel member, a second barrel member, an end cap unit, and a thermoelectric cooling chip. The first barrel member defines a first vortex space. The end cap unit includes a first end cap connected to the first barrel member, a second end cap connected to the second barrel member, and a connecting member interconnecting the first end cap and the second barrel member. The first end cap has two first openings in communication with the first vortex space. The second end cap has two second openings. The connecting member and the second barrel member define a second vortex space in communication with the second openings. The first vortex space and the second vortex space are isolated from each other. The thermoelectric cooling chip is disposed between the first end cap and the connecting member for reducing a temperature of a fluid flowing therethrough.

### CROSS-REFERENCE TO RELATED APPLICATION

This application claims priority to Taiwanese Invention Patent Application No. 114114249, filed on Apr. 15, 2025, the entire disclosure of which is incorporated by reference herein.

### FIELD

The disclosure relates to a cooling device, and more particularly to a cyclone cooling device

### BACKGROUND

As shown in FIG. 1, a convention cooling device as disclosed in Taiwanese invention Patent No. I577960 includes a tubular member 11, two end caps 12 removably closing the tubular member 11, and a guiding tubular set 13 mounted between the tubular member 11 and the two end caps 12. Each of the end caps 12 has an inlet opening 121 and an outlet opening 122. The guiding tubular set 13 includes a fixed tubular member 131 and a connection tubular member 132 that are respectively connected to the two end caps 12, and a rotary tubular member 133 that is movably disposed on the connection tubular member 132. A connection opening 134 is formed between the rotary tubular member 133 and the fixed tubular member 131. The rotary tubular member 133 is operable to move relative to the connection tubular member 132 for adjusting a size of the connection opening 134. A low-temperature fluid inside the guiding tubular set 13 flows out of the guiding tubular set 13 through the connection opening 134 and is mixed with a high-temperature fluid outside the guiding tubular set 13 so as to reduce temperature of the high-temperature fluid. The size of the connection opening 134 is adjustable to adjust a flow rate of the low temperature fluid, thereby adjusting a temperature of a mixture of the low-temperature fluid and the high-temperature fluid.

As the high-temperature fluid is mixed with the low-temperature fluid, the temperature of the high-temperature fluid may be reduced. However, a cooling range is dependent on an amount of the low-temperature fluid available. As a result, the temperature of the mixture of the high-temperature fluid and the low-temperature fluid ranges between the temperature of the high-temperature fluid and a temperature of the low-temperature fluid. In addition, in the conventional cooling device, the mixture of the high-temperature fluid and the low-temperature fluid may be contaminated by the low-temperature fluid flowing through a pathway, and a selection of the low-temperature fluid is also limited, so there is room for improvement in temperature reduction and in user friendliness of the conventional cooling device.

### SUMMARY

Therefore, an object of the disclosure is to provide a cyclone cooling device that can alleviate at least one of the drawbacks of the prior art.

According to the disclosure, the cyclone cooling device includes a barrel unit, an end cap unit, and a thermoelectric cooling unit.

The barrel unit includes a first barrel member and a second barrel member that are arranged along an axis and spaced apart from each other. The first barrel member surrounds the axis and has a top end portion and a bottom end portion that are opposite to each other along the axis. The first barrel member defines a first vortex space. A bottom end of the first vortex space is closed. The second barrel member surrounds the axis and has a top end portion and a bottom end portion that are opposite to each other along the axis.

The end cap unit includes a first end cap that is connected to the top end portion of the first barrel member, a second end cap that is connected to the top end portion of the second barrel member, and a connecting member that interconnects the first end cap and the second barrel member. The first end cap has two first openings that are offset from each other and that are in spatial communication with the first vortex space. The second end cap has two second openings that are offset from each other. The connecting member and the second barrel member cooperatively define a second vortex space that is in spatial communication with the second openings. The first vortex space and the second vortex space are isolated from each other.

The thermoelectric cooling unit includes a thermoelectric cooling chip that is disposed between and in contact with the first end cap and the connecting member, and that is adapted for reducing a temperature of a fluid flowing therethrough.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a sectional view illustrating a conventional cooling device as disclosed in Taiwanese invention Patent No. I577960.

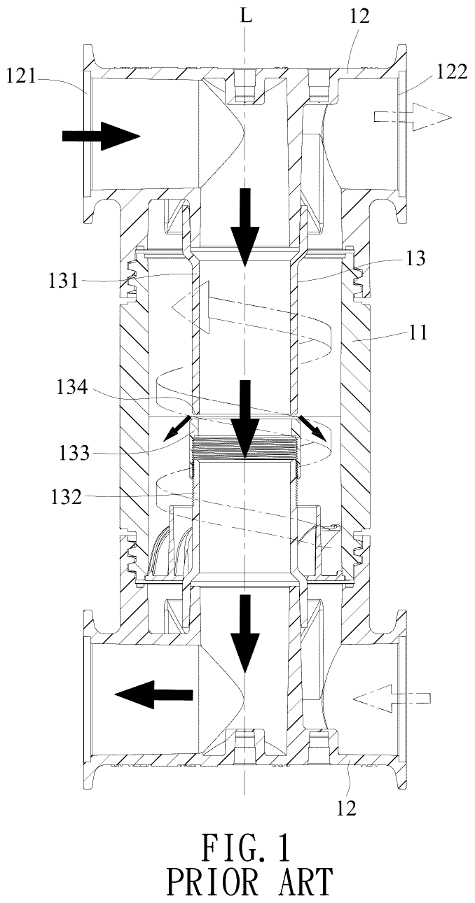

FIG. 2 is a perspective view illustrating a cyclone cooling device according to a first embodiment of the disclosure.

FIG. 3 is an exploded perspective view of the first embodiment illustrating the cyclone cooling device.

FIG. 4 is a sectional view of the first embodiment illustrating the cyclone cooling device.

FIG. 5 is a fragmentary sectional view of the first embodiment illustrating a ring member and a guiding unit of the cyclone cooling device.

FIG. 6 is a view taken along line VI-VI of FIG. 5.

FIG. 7 is a sectional view illustrating a cyclone cooling device according to a second embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

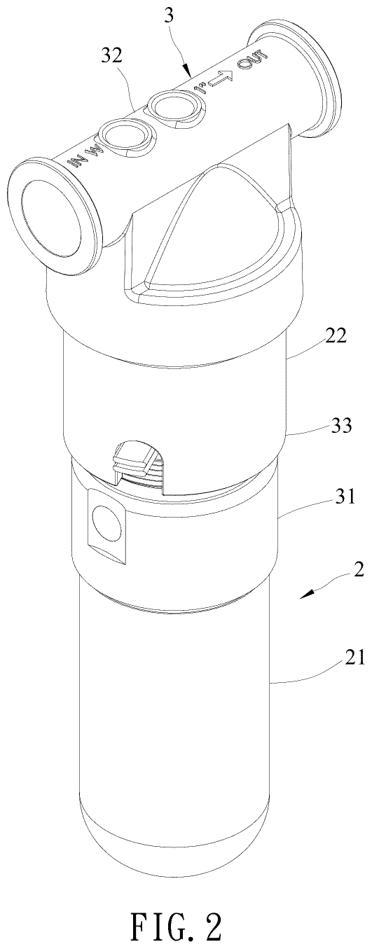

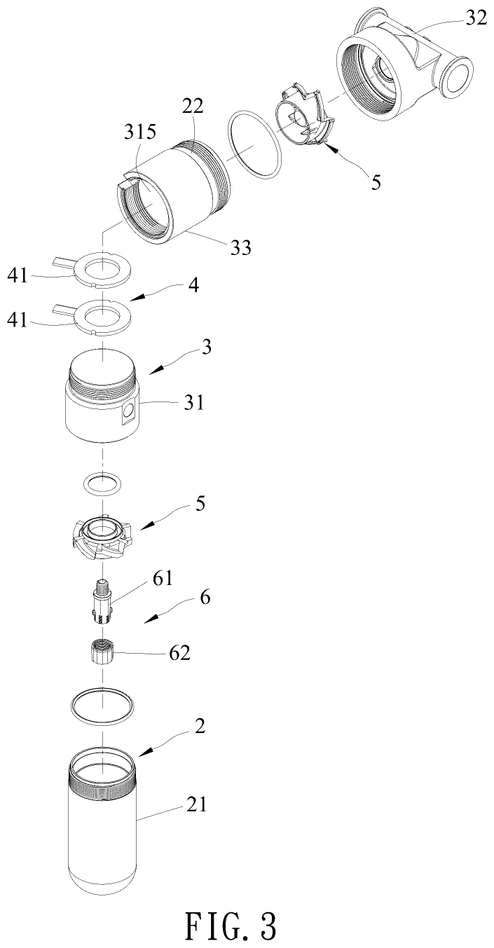

Referring to FIGS. 2, 3 and 4, a cyclone cooling device according to an embodiment of the disclosure includes a barrel unit 2, an end cap unit 3, a thermoelectric cooling unit 4, two ring members 5, and a guiding unit 6.

The barrel unit 2 includes a first barrel member 21 and a second barrel member 22 that are arranged along an axis (L) and that are spaced apart from each other. The first barrel member 21 surrounds the axis (L) and has a top end portion 212 and a bottom end portion 213 that are opposite to each other along the axis (L). The first barrel member 21 defines a first vortex space 211. A bottom end of the first vortex space 211 is closed. The second barrel member 22 surrounds the axis (L) and has a top end portion 222 and a bottom end portion 223 that are opposite to each other along the axis (L). The bottom end portion 223 of the second barrel member 22 is open along the axis (L).

The end cap unit 3 includes a first end cap 31 that is connected to the top end portion 212 of the first barrel member 21, a second end cap 32 that is connected to the top end portion 222 of the second barrel member 22, and a connecting member 33 that interconnects the first end cap 31 and the second barrel member 22. The first end cap 31 has two first openings 318 that are offset from each other and that are in spatial communication with the first vortex space 211. The second end cap 32 has two second openings 326 that are offset from each other. The first end cap 31 includes a first tubular portion 312 that surrounds the axis (L) and that defines a first tubular space 311 therein, and a first main portion 314 that surrounds the first tubular portion 312 and that cooperates with the first tubular portion 312 to define a first curved space 313. The first main portion 314 has a first connecting section 316 that is formed in a side surface thereof. The second end cap 32 includes a second tubular portion 322 that surrounds the axis (L) and that defines a second tubular space 321 therein, and a second main portion 324 that surrounds the second tubular portion 322 and that cooperates with the second tubular portion 322 to define a second curved space 323. The second main portion 324 is mounted to the second barrel member 22. The connecting member 33 has an end cover 331 that is connected to the second barrel member 22, a protrusion 332 that extends from the end cover 331 along the axis (L), and a second connecting section 333 that is formed on the protrusion 332, that extends in a direction of the axis (L), and that engages with the first connecting section 316. The end cover 331 of the connecting member 33 closes the bottom end portion 223 of the second barrel member 22. The connecting member 33 and the second barrel member 22 cooperatively define a second vortex space 221 that is in spatial communication with the second openings 326. The first vortex space 211 and the second vortex space 221 are isolated from each other. In this embodiment, the end cover 331 cooperates with a top end of the first main portion 314 to define a mounting groove 315, and the top end portion 222 of the second barrel member 22 and the second main portion 324 of the second end cap 32 are threadedly connected to each other. The bottom end portion 223 of the second barrel member 22 and the end cover 331 of connecting member 33 are integrally formed as one piece. However, in other embodiments, the top end portion 222 of the second barrel member 22 and the second end cap 32 may be formed as one-piece. The bottom end portion 223 of the second barrel member 22 and the end cover 331 of the connecting member 33 may be threadedly connected to each other.

The thermoelectric cooling unit 4 includes two thermoelectric cooling chips 41 that are disposed between and are respectively in contact with the first end cap 31 and the connecting member 33, and that are adapted for reducing a temperature of a fluid flowing therethrough. The mounting groove 315 of the first end cap 31 retains the thermoelectric cooling chips 41. According to Peltier Effect, the thermoelectric cooling chips 41, when being electrically energized, may absorb heat energy to substantially reduce the temperature of the fluid flowing therethrough. In other embodiments, the quantity of the thermoelectric cooling chips 41 may be, but not limited to, one or greater than three.

The two ring members 5 are connected respectively to the first end cap 31 and the second end cap 32, and are adapted for guiding fluids in the first vortex space 211 and the second vortex space 221 to form vortices, respectively.

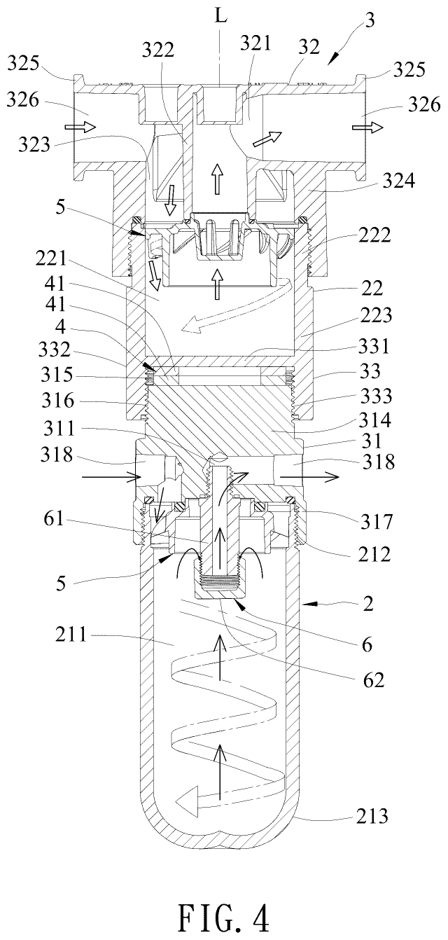

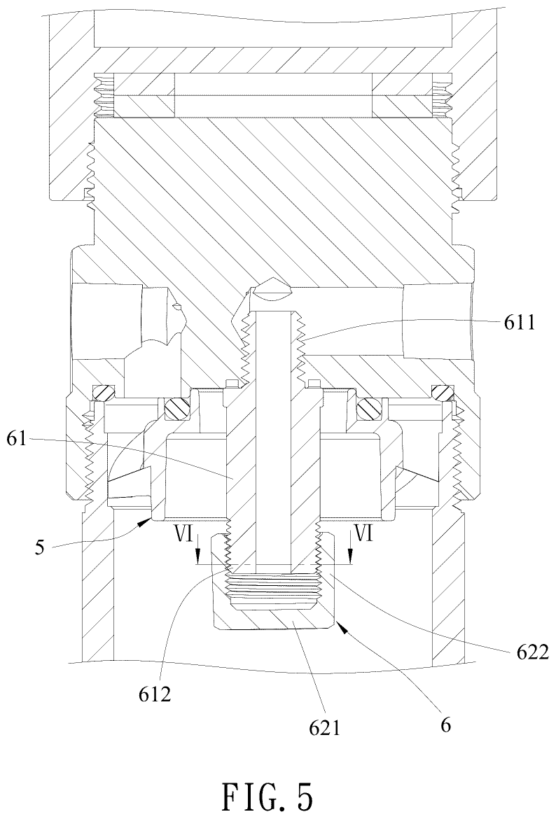

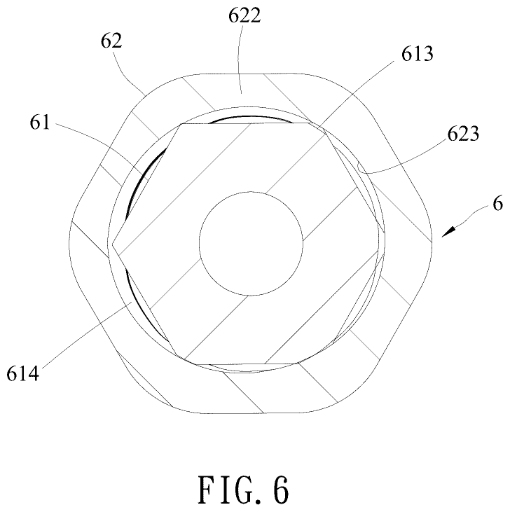

With reference to FIGS. 4, 5, and 6, the guiding unit 6 is disposed between the first barrel member 21 and the first end cap 31. The guiding unit 6 includes a tubular member 61 and a turning member 62. The tubular member 61 extends along the axis (L), and has a connecting end portion 611 and a drawing end portion 612. The connecting end portion 611 of the tubular member 61 is connected to the first end cap 31, and is adjacent to and in spatial communication with one of the first openings 318. The drawing end portion 612 of the tubular member 61 is opposite to the connecting end portion 611 along the axis (L). The turning member 62 is mounted to the drawing end portion 612 of the tubular member 61, and cooperates with the drawing end portion 612 to define a plurality of passages 614. The plurality of passage 614 are in spatial communication with an inner space of the tubular member 61 and the first vortex space 211. The plurality of passages 614 are formed between the drawing end portion 612 of the tubular member 61 and the surrounding wall 622 of the turning member 62, and are angularly spaced apart from each other around the axis (L). The turning member 62 includes a base wall 621 that is transverse to the axis (L), and a surrounding wall 622 that extends from a periphery of the base wall 621 along the axis (L) toward the connecting end portion 611, and that surrounds the tubular member 61. A contour of the drawing end portion 612 has a polygonal prismatic shape. The drawing end portion 612 has a plurality of external threads 613 that are formed respectively on vertices of the drawing end portion 612 and that extend in a direction of the axis (L). The surrounding wall 622 has an inner surface that is formed with an internal thread 623 engaging threadedly with the external threads 613. In this embodiment, the contour of the drawing end portion 612 has a regular hexagonal prismatic shape. The surrounding wall 622 is substantially a circumscribed circle of the drawing end portion 612. The spaces formed by the external threads 613, the six sides of the drawing end portion 612 in which has the regular hexagonal prismatic shape, and the enclosing wall 622 are the plurality of passages 614.

In this embodiment, each of the barrel unit 2, the end cap unit 3, the two ring members 5, and the guiding unit 6 is made of metal, such as copper or aluminum, thereby increasing heat transmission efficiency.

During operation, after being electrically energized, the thermoelectric cooling chips 41 absorb the heat energies of the first end cap 31 and the first barrel member 21, and release the heat energies to the second barrel member 22 and the second end cap 32 so that the temperatures of the first end cap 31 and the first barrel member 21 are reduced, thereby reducing the temperature of a fluid flowing through the first vortex space 211. As a result, the fluid after flowing out of the first vortex space 211 may cool other objects such as knives or workpieces. The fluid flowing through the second vortex space 221 may take away the heat energy released by the thermoelectric cooling chips 41 so as to prevent the temperatures of the second barrel member 22 and the second end cap 32 from being too high. By virtue of heat absorption of the thermoelectric cooling chips 41, the temperature of the fluid flowing out of the first vortex space 211 may be below zero degrees or below minus twenty degrees.

In comparison with the existing cooling device, by virtue of the first vortex space 211 and the second vortex space 221 of the disclosure being isolated from each other and being in spatial communication with the two first openings 318 and the two second openings 326, and by virtue of the temperature being reduced by the thermoelectric cooling chips 41 instead of by mixing a low-temperature fluid and a high-temperature fluid, the fluid flowing through the first vortex space 211 does not need to be mixed with the fluid flowing through the second vortex space 221, and the cooling effect is dependent on the heat absorption effect of the thermoelectric cooling chips 41 rather than the temperature of the fluid flowing through the second vortex space 221. Furthermore, by virtue of the first vortex space 211 and the second vortex space 221 being isolated from each other, the fluid flowing through the first vortex space 211 may be different from the fluid flowing through the second vortex space 221. To quickly reduce and regulate the temperature in the second vortex space 221, the fluid flowing through the first vortex space 221 may be air, ice water or a nitrogen liquid. Moreover, by virtue of the heat conduction of the components connected to each other, the temperature of the fluid flowing through the first vortex space 211 may be further reduced. Additionally, the two ring members 5 guide the fluids in the first vortex space 211 and the second vortex space 221 to form vortices so that impurities may be removed from the fluids, thereby achieving filtering a fluid.

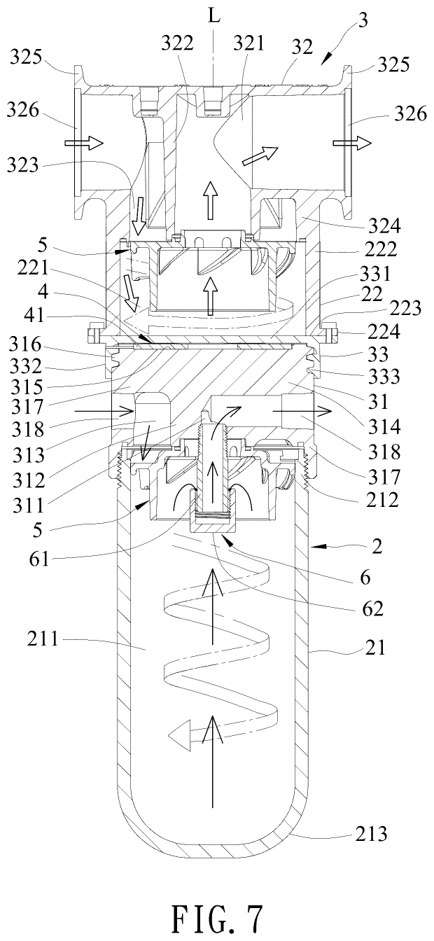

FIG. 7 illustrates a cyclone cooling device according to a second embodiment of the disclosure, which has a structure generally similar to that of the first embodiment. However, the differences between the second embodiment and the first embodiment reside in that the top end portion 222 of the second barrel member 22 and the second main portion 324 of the second end cap 32 are integrally formed as one-piece, and the second barrel member 22 further has a fixing portion 224 that protrudes outwardly from an outer surrounding surface of the bottom end portion 223. In the second embodiment, the end cover 331 of the connecting member 33 is fixed to the fixing portion 224 of the second barrel member 22 by screws.

As a result, the second embodiment may achieve a same effect as the first embodiment.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A cyclone cooling device comprising:
a barrel unit including a first barrel member and a second barrel member that are arranged along an axis and spaced apart from each other, said first barrel member surrounding the axis and having a top end portion and a bottom end portion that are opposite to each other along the axis, said first barrel member defining a first vortex space, a bottom end of said first vortex space being closed, said second barrel member surrounding the axis and having a top end portion and a bottom end portion that are opposite to each other along the axis;
an end cap unit including a first end cap that is connected to said top end portion of said first barrel member, a second end cap that is connected to said top end portion of said second barrel member, and a connecting member that interconnects said first end cap and said second barrel member, said first end cap having two first openings that are offset from each other and that are in spatial communication with said first vortex space, said second end cap having two second openings that are offset from each other, said connecting member and said second barrel member cooperatively defining a second vortex space that is in spatial communication with said second openings, said first vortex space and said second vortex space being isolated from each other; and
a thermoelectric cooling unit including a thermoelectric cooling chip that is disposed between and in contact with said first end cap and said connecting member, and that is adapted for reducing a temperature of a fluid flowing therethrough.

2. The cyclone cooling device as claimed in claim 1, further comprising two ring members that are connected respectively to said first end cap and said second end cap, and that are adapted for guiding fluids in said first vortex space and said second vortex space to form vortices.

3. The cyclone cooling device as claimed in claim 1, further comprising a guiding unit that is disposed between said first barrel member and said first end cap, said guiding unit including:
a tubular member that extends along the axis, and that has
a connecting end portion connected to said first end cap, and being adjacent to and in spatial communication with one of said first openings, and
a drawing end portion opposite to said connecting end portion along the axis; and
a turning member that is mounted to said drawing end portion of said tubular member, and that cooperates with said drawing end portion to define at least one passage, said at least one passage being in spatial communication with an inner space of said tubular member and said first vortex space.

4. The cyclone cooling device as claimed in claim 3, wherein each of said barrel unit, said end cap unit, and said guiding unit is made of metal.

5. The cyclone cooling device as claimed in claim 3, wherein said turning member includes a base wall that is transverse to the axis, and a surrounding wall that extends from a periphery of said base wall along the axis toward said connecting end portion, and that surrounds said tubular member.

6. The cyclone cooling device as claimed in claim 5, wherein:
a contour of said drawing end portion has a polygonal prismatic shape;
said drawing end portion has a plurality of external threads that are formed respectively on vertices of said drawing end portion and that extend in a direction of the axis; and
said surrounding wall has an inner surface that is formed with an internal thread engaging threadedly with said external threads.

7. The cyclone cooling device as claimed in claim 6, wherein said at least one passage includes a plurality of passages that are formed between said drawing end portion of said tubular member and said surrounding wall of said turning member, and that are angularly spaced apart from each other around the axis.

8. The cyclone cooling device as claimed in claim 1, wherein:
said first end cap includes a first tubular portion that surrounds the axis and that defines a first tubular space therein, and a first main portion that surrounds said first tubular portion and that cooperates with said first tubular portion to define a first curved space;
said first main portion has a first connecting section that is formed at a side surface thereof; and
said connecting member has an end cover that is connected to said second barrel member, a protrusion that extends from said end cover along the axis, and a second connecting section that is formed on said protrusion, that extends in a direction of the axis, and that engages with said first connecting section, said end cover cooperating with a top end of said first main portion to define a mounting groove that retains said thermoelectric cooling chip.

9. The cyclone cooling device as claimed in claim 8, wherein said second end cap includes a second tubular portion that surrounds the axis and that defines a second tubular space therein, and a second main portion that surrounds said second tubular portion and that cooperates with said second tubular portion to define a second curved space, said second main portion being mounted to said second barrel member.

10. The cyclone cooling device as claimed in claim 9, wherein:
said second barrel member further has a fixing portion that protrudes outwardly from an outer surrounding surface of said bottom end portion; and
said end cover of said connecting member is mounted to said fixing portion of said second barrel member.
